(19) United States
(12) Patent Application Publication
(10) Pub. No.: US 2022/0166113 A1
(43) Pub. Date: May 26, 2022

(54) BATTERY CELL ASSEMBLY HAVING GAS EXHAUST AND HEAT EMISSION FUNCTION

(71) Applicant: Deuk Yong LEE, Anseong-si (KR)

(72) Inventor: Deuk Yong LEE, Anseong-si (KR)

(21) Appl. No.: 17/600,589

(22) PCT Filed: Apr. 24, 2019
(86) PCT No.: PCT/KR2019/004937

§ 371 Date: Sep. 30, 2021

(30) Foreign Application Priority Data
Apr. 1, 2019 (KR) 10-2019-0037700

(51) Int. Cl. H01M 50/517; H01M 50/213; H01M 50/35; H01M 10/6554; H01M 10/613; H01M 10/653

(52) U.S. Cl. CPC H01M 50/517; H01M 50/213; H01M 10/653; H01M 10/6554; H01M 10/613; H01M 50/35

(57) ABSTRACT

A battery cell assembly according to the present invention may comprise: a battery cell array including a plurality of battery cells; a pair of holder plates which are made of an electric insulation material, are arranged at both ends of the battery cell array to face each other, and include position fixing grids which are provided on the inner surfaces thereof, respectively, are spaced apart from each other, and fix respective positions of the plurality of battery cells; and a plurality of contact bolts made of an electroconductive material are arranged at positions corresponding to electrode terminals of the plurality of battery cells, respectively, wherein one-side ends of the contact bolts are in electric contact with the electrode terminals of the battery cells and the other-side ends thereof are disposed to protrude from the outer surfaces of the holder plates, respectively.

### TECHNICAL FIELD

The present invention relates to a battery cell assembly including a plurality of battery cells.

### BACKGROUND ART

Recently, rechargeable batteries that can be charged or discharged are widely used not only in small products such as mobile devices, but also in middle-size and large-size devices such as electric vehicles, and have been gradually applied to products in various fields. One or at last two battery cells may be applied per a device for a small mobile product, but a middle/large-sized battery module in which a plurality of battery cells are electrically connected is used in a middle/large device such as an electric vehicle due to the need for high output and large capacity.

A secondary battery is classified into a lithium ion battery, a lithium ion polymer battery, a lithium polymer battery, etc. according to the composition of the electrode and the electrolyte, and is classified into a cylindrical battery, a prismatic battery, and a pouch-type battery according to the shape of the battery case. In this case, the cylindrical battery generally has a higher energy density than the prismatic and pouch-type batteries. However, due to the external characteristics of the cylindrical battery, it is difficult to maintain the arrangement in a stacked structure. Conventionally, after arranging cylindrical batteries and fixing them with a tape, the electrode terminals of each battery are electrically connected through welding such as spot welding.

FIG. 1 illustrates an example of a battery module formed in a conventional cylindrical battery. As shown in FIG. 1, the conventional battery module 50 includes an array 30 including a plurality of cylindrical batteries 10 and a panel-shaped bus bar 20 electrically connecting electrode terminals of each of the batteries 10. In this case, the electrode terminal of the battery 10 is electrically connected to the bus bar 20 by welding.

The battery module constructed by the above-described method has the following problems. That is, since it is necessary to use a bus bar made of nickel or a nickel alloy having relatively low electrical conductivity for welding the electrode terminal and the bus bar, a copper panel with excellent electrical conductivity cannot be used so that there is relative current loss of the battery cell. In addition, the bus bar is simultaneously connected to the plurality of batteries by welding, and it is not easy to determine whether the connection between the electrode terminals of each of the plurality of batteries and the bus bar is normal during the assembly process. If a connection defect is found between one battery and the bus bar after assembly, the entire assembled battery module may be discarded.

In addition, since the connection by welding is weak to external shock or heat generated during the use of the battery module, a connection defect between the bus bar and the electrode terminal may occur during use of the battery module. As described above, when a connection defect occurs between the bus bar and any one electrode terminal during use, it is difficult to selectively weld only the defective battery to the bus bar, so that the entire battery module may be inevitably discarded. Furthermore, it is difficult to manufacture the conventional battery module manufactured in the above-described manner in a stacked structure, and thus has a disadvantage in terms of space utilization due to a low degree of freedom for the structural design.

### DISCLOSURE

### Technical Problem

To solve the above-described problems, an object of the present invention is to provide a battery cell assembly configured by using a cylindrical battery cell, in which the electrical connection to a unit battery cell can be individually checked and repaired, electrical connection failure due to external impact or heat generation of the battery can be prevented in use, and a cylindrical battery can be easily designed into a battery module having various structures.

In addition, another object of the present invention is to provide a battery cell assembly that can be mechanically combined in various forms according to electrical array configuration conditions. That is, the present invention provides a battery cell assembly that is easy to fabricate a battery cell assembly having various voltages and electric capacities in various structures to meet customer requirements according to the purpose of use of the secondary battery.

Still another object of the present invention is to provide a battery cell assembly that can prevent a chain explosion of neighboring battery cells by allowing gas generated from the inside of the battery cell due to heat generation in use to be smoothly exhausted, and furthermore, has a structure in which heat generated from an array panel for circuit configuration can be effectively dissipated.

The technical objects of the present invention are not limited to the above-mentioned one, and the other unmentioned technical objects and advantages will become apparent from the following description.

### Technical Solution

According to the present invention, a battery cell assembly includes a battery cell array including a plurality of battery cells; a pair of holder plates which are made of an electric insulation material, are arranged at both ends of the battery cell array to face each other, and include position fixing grids which are provided on inner surfaces thereof, respectively, are spaced apart from each other, and fix respective positions of the plurality of battery cells; and a plurality of contact bolts made of an electroconductive material, arranged at positions corresponding to electrode terminals of the plurality of battery cells, respectively, wherein one-side ends of the contact bolts are in electric contact with the electrode terminals of the battery cells and other-side ends thereof are disposed to protrude from outer surfaces of the holder plates, respectively.

In this case, the contact bolt may include a disc-shaped flange formed with a contact protrusion; a body part having a diameter smaller than a diameter of the flange; and a male screw part formed on one end of the body part.

In this case, the holder plate may include a receiving groove formed on an inner surface to which an end of the battery cell array is connected to receive the flange of the contact bolt; and gas exhaust grooves formed between adjacent receiving grooves to allow the receiving grooves to communicate with each other, the adjacent receiving grooves being formed to correspond to each of the plurality of battery cells.

In this case, the holder plate may further include a plurality of cross ribs formed at a predetermined height from an outer surface of the holder plate and crossed with each other; and a plurality of heat dissipation space parts divided by the plurality of cross ribs.

In addition, the contact bolt may further include a fixing part formed integrally with the body part and having a diameter larger than a diameter of the body part to fix the body part to the holder plate.

In a battery cell assembly according to the present invention, the battery cell array may include one or more unit arrays; and an array panel electrically connected to the contact bolt connected to each of a plurality of battery cells constituting the unit array.

In this case, the battery cell assembly may further include an insulating panel disposed under the array panel to be supported by the cross rib to electrically separate the array panel and the holder plate and to block heat generated from the array panel from being transferred to the holder plate.

Meanwhile, the heat dissipation space part may dissipate heat generated from the array panel by bringing the heat into contact with outside air.

The battery cell assembly according to the present invention may further include a fastening link for fastening holder plates of an adjacent battery cell assembly to each other.

In this case, the fastening link may include a body part provided with a seating surface for the holder plate; a pair of fastening legs extending parallel to each other from the seating surface while being spaced apart from each other; hooks provided at one end of each of the pair of fastening legs and protruding in a direction to face each other; and tension parts provided on each of the pair of fastening legs and protruding in opposition to each other.

In addition, the holder plate may include a plurality of link insertion holes formed symmetrically in two peripheries of the holder plate including four peripheries, in which the two peripheries face each other, wherein each of the plurality of link insertion holes includes a support surface part flattened in an opening direction of the link insertion hole; a stopper provided on an opposite side of the support surface part and supporting the seating surface provided on the body part of the fastening link; a guide groove extending from the stopper to guide an entry of the fastening leg of the fastening link; and a fixing rib formed on one end of the guide groove to fix the hook of the fastening link.

The fastening link may further include a removal part for separating the fastening link from the holder plate on one surface opposite to the seating surface of the body part.

In addition, the fastening link may be formed with first and second seating surfaces on both surfaces of the body part facing each other, and the first and second seating surfaces may be formed with a pair of first fastening legs and a pair of second fastening legs having a same shape and including the hook and the tension part, respectively.

In addition, the fixing rib may include an inclined surface part inclined toward the support surface part.

### Advantageous Effects

According to the present invention, it is possible to provide a battery cell assembly configured by using a cylindrical battery cell, in which the electrical connection to a unit battery cell can be individually checked and repair, electrical connection failure due to external impact or heat generation of the battery can be prevented in use, and a cylindrical battery can be easily designed into a battery module having various structures.

In particular, according to the battery cell assembly of the present invention, it is possible to prevent connection failure due to external shock and heat generation of the battery cell, which is a problem in a conventional battery module manufactured by a welding method. In addition, in the present invention, a copper panel having excellent electrical conductivity may be used as a circuit panel. Conventionally, since the electrode terminal of the unit battery cell needs to be connected to the bus bar by a welding method, a copper panel may not be used. However, since the battery cell assembly according to the present invention does not use a welding method, it is possible to use a copper panel having excellent electrical conductivity. When the array panel is constructed using copper, the internal resistance of the battery cell assembly can be minimized, and it is effective in stabilizing the electrical capacity of the battery module.

In addition, the contact state between each battery cell and the contact bolt can be easily checked after assembly or during use. In the battery cell assembly according to the present invention, since individual battery cells, contact bolts and array panels are mechanically assembled, it is relatively easy to replace the corresponding battery cells when a defect occurs in a specific battery cell. Accordingly, unlike the related art, when a defect occurs in the battery module during use, the product can be easily repaired, so that not only the overall manufacturing cost, but also the customer service cost can be significantly reduced.

In addition, when the assembled battery pack according to the present invention is used, even when a cylindrical battery is applied, it is very easy to manufacture battery cell assemblies having various voltages and electric capacities in various structures according to the purpose of use of the secondary battery.

In addition, when the battery cell assembly according to the present invention is used, even when gas is emitted due to heat in one of the plurality of battery cells constituting the array, the gas can be smoothly exhausted to the outside, so that it is possible to effectively prevent chain explosion of neighboring battery cells. In particular, when the array panel is formed using a copper panel having excellent electrical conductivity, heat generated from the array panel can be effectively dissipated.

### DESCRIPTION OF DRAWINGS

FIG. 1 is a view exemplarily showing a battery cell assembly by a conventional welding scheme.

FIG. 2 is a perspective view of a battery cell assembly according to the present invention.

FIGS. 3 and 4 are perspective views respectively showing upper and lower surfaces of a holder plate constituting a battery cell assembly according to the present invention.

FIG. 5 is a perspective view illustrating a contact bolt used in a battery cell assembly according to the present invention.

FIG. 6 is a partial cross-sectional view showing a connection structure of an electrode terminal, a contact bolt, and a contact hole provided in a battery cell in a battery cell assembly according to the present invention.

FIG. 7 is a perspective view showing a contact bolt according to another embodiment, and FIG. 8 is a cross-sectional view showing a state in which the contact bolt is fastened to the holder plate.

FIG. 9 is a perspective view illustrating an example of configuring one battery pack by including a plurality of battery cell assemblies according to the present invention.

FIG. 10 is a perspective view illustrating a fastening link for configuring an assembled battery pack according to an embodiment of the present invention.

FIG. 11 is a cross-sectional view illustrating a cross-section taken along the line I-I of FIG. 9.

FIG. 12 is an enlarged cross-sectional view of area A of FIG. 11.

FIG. 13 is a view showing a state in which a link insertion hole is formed in a holder plate used in a battery cell assembly according to the present invention, and

FIG. 14 is an enlarged view showing an area in which a fixing rib is formed in FIG. 13.

FIG. 15 is a perspective view showing a fastening link according to another embodiment used for stacking the battery cell assembly according to the present invention in the vertical direction.

FIG. 16 is a schematic diagram showing that a battery module having a vertically stacked structure can be configured by providing a plurality of battery cell assemblies according to the present invention.

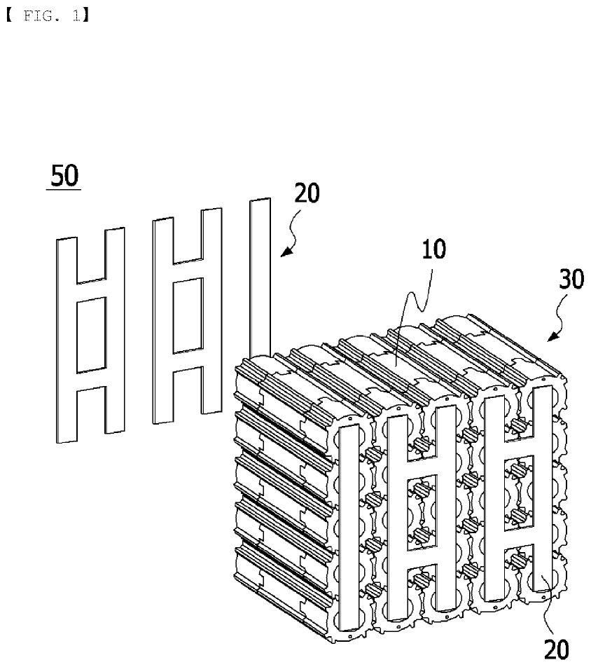

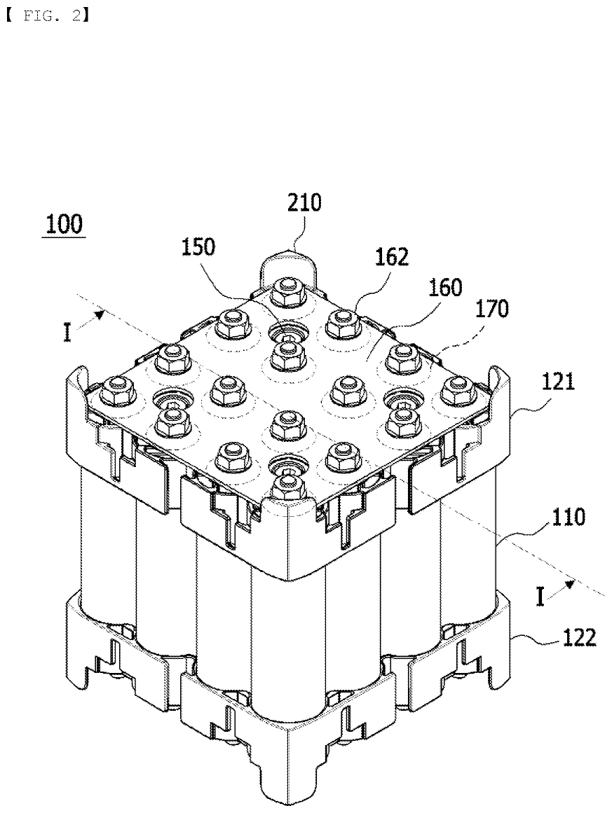

### BEST MODE

According to the present invention, a battery cell assembly may include a battery cell array including a plurality of battery cells; a pair of holder plates which are made of an electric insulation material, are arranged at both ends of the battery cell array to face each other, and include position fixing grids which are provided on inner surfaces thereof, respectively, are spaced apart from each other, and fix respective positions of the plurality of battery cells; and a plurality of contact bolts made of an electroconductive material, arranged at positions corresponding to electrode terminals of the plurality of battery cells, respectively, wherein one-side ends of the contact bolts are in electric contact with the electrode terminals of the battery cells and other-side ends thereof are disposed to protrude from outer surfaces of the holder plates, respectively.

In this case, the contact bolt may include a disc-shaped flange formed with a contact protrusion; a body part having a diameter smaller than a diameter of the flange; and a male screw part formed on one end of the body part.

In this case, the holder plate may include a receiving groove formed on an inner surface to which an end of the battery cell array is connected to receive the flange of the contact bolt; and gas exhaust grooves formed between adjacent receiving grooves to allow the receiving grooves to communicate with each other, the adjacent receiving grooves being formed to correspond to each of the plurality of battery cells.

In this case, the holder plate may further include a plurality of cross ribs formed at a predetermined height from an outer surface of the holder plate and crossed with each other; and a plurality of heat dissipation space parts divided by the plurality of cross ribs.

In addition, the contact bolt may further include a fixing part formed integrally with the body part and having a diameter larger than a diameter of the body part to fix the body part to the holder plate.

In a battery cell assembly according to the present invention, the battery cell array may include one or more unit arrays; and an array panel electrically connected to the contact bolt connected to each of a plurality of battery cells constituting the unit array.

In this case, the battery cell assembly may further include an insulating panel disposed under the array panel to be supported by the cross rib to electrically separate the array panel and the holder plate and to block heat generated from the array panel from being transferred to the holder plate.

Meanwhile, the heat dissipation space part may dissipate heat generated from the array panel by bringing the heat into contact with outside air.

The battery cell assembly according to the present invention may further include a fastening link for fastening holder plates of an adjacent battery cell assembly to each other.

In this case, the fastening link may include a body part provided with a seating surface for the holder plate; a pair of fastening legs extending parallel to each other from the seating surface while being spaced apart from each other; hooks provided at one end of each of the pair of fastening legs and protruding in a direction to face each other; and tension parts provided on each of the pair of fastening legs and protruding in opposition to each other.

In addition, the holder plate may include a plurality of link insertion holes formed symmetrically in two peripheries of the holder plate including four peripheries, in which the two peripheries face each other, wherein each of the plurality of link insertion holes includes a support surface part flattened in an opening direction of the link insertion hole; a stopper provided on an opposite side of the support surface part and supporting the seating surface provided on the body part of the fastening link; a guide groove extending from the stopper to guide an entry of the fastening leg of the fastening link; and a fixing rib formed on one end of the guide groove to fix the hook of the fastening link.

The fastening link may further include a removal part for separating the fastening link from the holder plate on one surface opposite to the seating surface of the body part.

In addition, the fastening link may be formed with first and second seating surfaces on both surfaces of the body part facing each other, and the first and second seating surfaces may be formed with a pair of first fastening legs and a pair of second fastening legs having a same shape and including the hook and the tension part, respectively.

In addition, the fixing rib may include an inclined surface part inclined toward the support surface part.

### MODE FOR INVENTION

The detailed description set forth below in connection with the appended drawings is intended as a description of exemplary aspects of the invention and is not intended to represent the only exemplary aspects in which the invention can be practiced. Thus, the invention described herein is intended to embrace all such alternatives, modifications, variations and applications as may fall within the spirit and scope of the appended claims.

A detailed description of well-known features or functions will be ruled out in order not to unnecessarily obscure the gist of the present invention. While terms including ordinal numbers, such as “first” and “second,” etc., may be used to describe various components, such components are not limited by the above terms. The above terms are used only to distinguish one component from another.

Hereinafter, exemplary embodiments of the present invention will be described in detail with reference to the accompanying drawings.

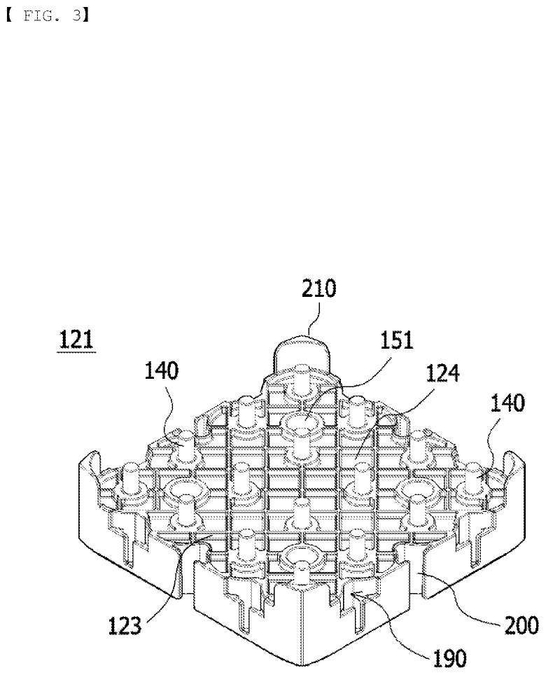

First, as shown in FIG. 2, a battery cell assembly 100 according to the present invention includes a battery cell array 110 including a plurality of battery cells 112, and a pair of holder plates 120 including a first holder plate 121 and a second holder plate 122 made of a seasonal insulating material and disposed on both ends of the battery cell array 110, respectively. In this case, the battery cell 112 is a cylindrical battery provided with an electrode terminal 112a functioning as a (+) terminal or a (−) terminal. Although FIG. 2 illustrates an example in which the plurality of battery cells 112 are arranged in an array structure having 4 rows and 4 columns, they may be arranged in an array structure having various numbers of matrices as needed.

The battery cell assembly 100 including the battery cell array of the above-described matrix structure is manufactured by assembling individual components to be described below.

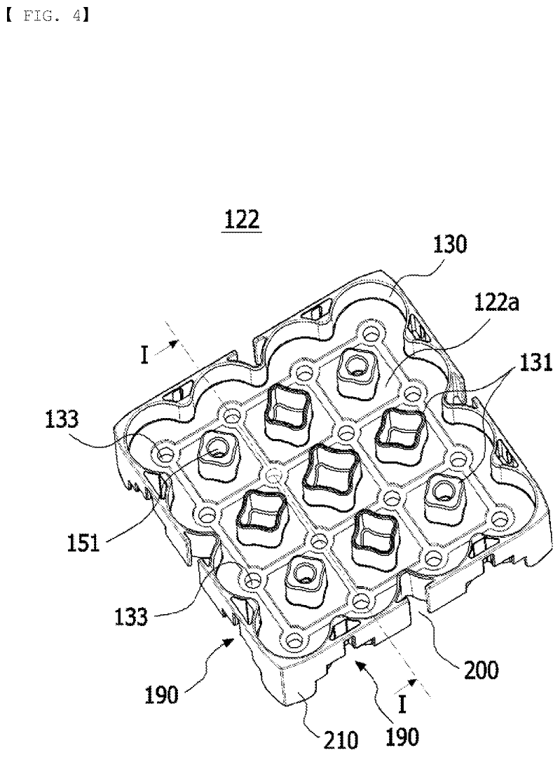

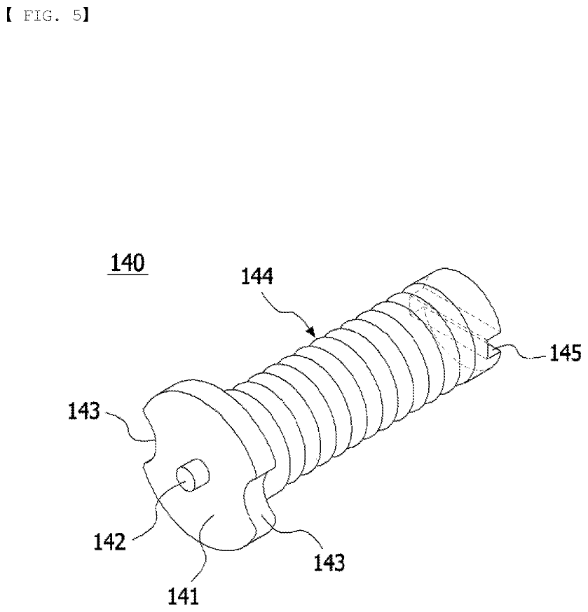

As shown in FIGS. 3 and 4, first and second holder plates 121 and 122 are disposed on both ends of the battery cell array 110 including the plurality of battery cells 112. The first and second holder plates 121 and 122 may be manufactured using an electrically insulating material, for example, a synthetic resin material. The holder plates 121 and 122 have a dimension that approximately covers both ends of the battery cell array 110, and may be used as a pair of holder plates having the same shape. An interpolation part 130 may be formed on an inner surface on which each of the holder plates 121 and 122 are in contact with the battery cell array 110. The end portion of the battery cell array 110 is accommodated in the interpolation part 130 on the inner surface of the holder plates 121 and 122, and the interpolation part 130 may be formed as a groove having a shape which is approximately the same as the side profile of the array 110 including the cylindrical battery cell 112, so that an end of the array 110 can be tightly fixed. In addition, the interpolation unit 130 may be formed with a position fixing grid 131 for fixing the position of each battery cell 112, and tightly fix each battery cell 112 constituting the array 110 by the grid 131 to the hold plates 121 and 122 while maintaining a constant gap between each battery cell 112 and the neighboring battery cells 112. In particular, an empty space may be formed between the battery cells 112 by the grid 131, and heat generated in the battery cell 112 may be easily discharged to the outside due to the space.

Meanwhile, the holder plates 121 and 122 are formed with a contact hole 133 at positions corresponding to the electrode terminal 112a provided in the individual battery cell 112. The contact hole 133 is formed through the holder plates 121 and 122. Then, a contact bolt 140 formed of an electrically conductive material is inserted into the contact hole 133.

One end of the contact bolt 140 is electrically in contact with the electrode terminal 112a of the battery cell 112, and the other end is disposed to protrude outward through the contact hole 133. In addition, the contact bolt 140 may be screw-fastened to the contact hole 133. That is, since the contact bolt 140 and the contact hole 133 are screwed together, one surface of the contact bolt 140 approaches toward the electrode terminal 112a when the contact bolt 140 is rotated in one direction and protrudes to the outside of the holder plates 121 and 122 when rotated in an opposite direction. That is, the contact distance between the flange 141 and the electrode terminal 112a may be precisely adjusted by adjusting the number of rotations of the contact bolt 140.

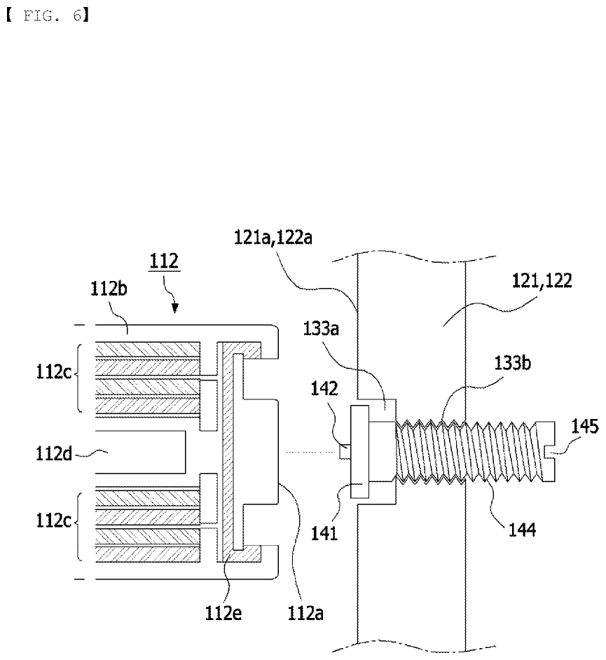

As shown in FIG. 5, the contact bolt 140 may include a disc-shaped flange 141 and a male screw portion 144 having a diameter smaller than that of the flange 141. In addition, a contact protrusion 142 protruding outwardly is formed on the flange 141 to improve the contact reliability between the contact bolt 140 and the electrode terminal 112a. In addition, a pair of rotating spheres 143 disposed to face each other are formed on the circumference of the flange 141. A rotating sphere 143, which is a unit for rotating the contact bolt 140, may rotate the contact bolt 140 by using a separate rotating tool fitted to the pair of rotating spheres 143. In addition, a concave groove 145 for a screwdriver may be formed in one end of the male screw portion 144 opposite to the flange 141. The concave groove 145 may be formed in various shapes, and may be a unit for rotating the contact bolt 140 on the opposite side of the pair of rotating spheres 143. The contact bolt 140 may be rotated after an end of a driver used as a screwdriver is inserted into the concave groove 145. The contact bolt 140 may be rotated at opposite sides to each other by using the pair of rotating spheres 143 and the grooves 145.

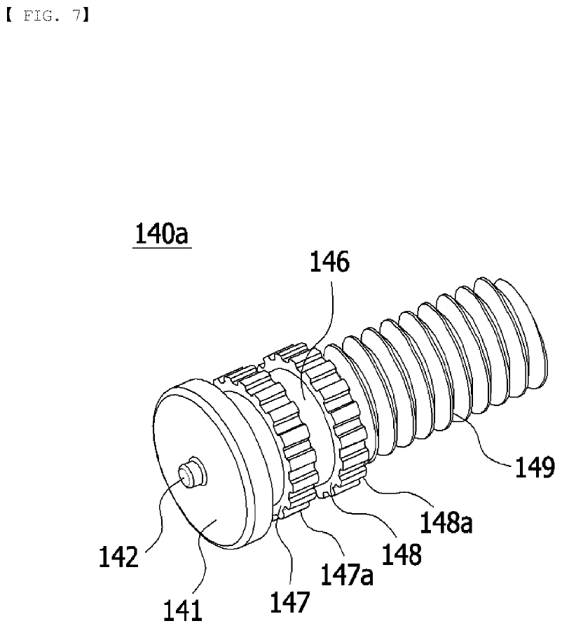

Referring to the fastening state of the electrode terminal 112a, the contact bolt 140, and the contact hole 133 shown in FIG. 6, a receiving groove 133a for receiving the flange 141 is provided in an area of the contact hole 133 on the inner side surfaces 121a and 122a of the holder plates 121 and 122, and a female screw part 133b is formed on the inner wall surface of the contact hole 133 to be screwed to the male screw part 144. When the contact bolt 140 is fastened into the contact hole 133, the flange 141 may move back and forth by a predetermined distance inside the receiving groove 133a.

In a state in which the plurality of contact bolts 140 are respectively fastened to the corresponding contact holes 133, each battery cell 112 is positioned at the interpolation part 130 and the grid 131 of each holder plate 121 and 122 to insert both ends of the array 110. Thereafter, the first holder plate 121 and the second holder plate 122 disposed opposite to each other are firmly fixed using a fastening unit 150. The fastening unit 150, which is a unit for physically and firmly fixing two opposite holder plates 121 and 122 to the array 110, may be fastened through an insertion hole 151 formed in some of the plurality of grids 131 by using, for example, a wrench bolt and a nut.

Meanwhile, when the end of the array 110 is in close contact with the inner surfaces of the holder plates 121 and 122, a gap may be generated between the electrode terminal 112a and the contact bolt 140 of the specific battery cells 112 due to the height difference between the individual battery cells 112. After assembling the holder plates 121 and 122 and the array 110, the contact bolt 140 may be rotated to precisely adjust the contact with each battery cell 112. In this case, the contact bolt 140 is rotated such that the flange 141 and the contact protrusion 142 can be in close contact with the corresponding electrode terminal 112a using the concave groove 145. When the voltage between the positive terminals of each battery cell 112 is measured, the connection state between the individual contact bolt 140 and the battery cell 112 may be checked. In particular, the contact protrusion 142 is brought into contact while digging into the surface of the electrode terminal 112a, thereby improving electrical contact reliability between the battery cell 112 and the contact bolt 140.

In the assembled battery cell assembly 100 assembled in the above-described manner, each of the holder plates 121 and 122 is closely fixed to the array 110, and one end of the contact bolt 140 passes through the contact hole 133 to be exposed to the outside. An array panel 160 connecting the plurality of battery cells 112 constituting a unit array in parallel to each other is connected to the exposed contact bolt 140. In this case, the array panel 160 disposed on the outer surface of the holder plates 121 and 122 is provided with a plurality of openings through which one end of the contact bolt 140 passes. The end of the contact bolt 140 corresponding to the battery cell 112 to be connected in parallel may be exposed through an opening formed in the array panel 160, and the exposed end of the contact bolt 140 may be electrically connected to the array panel 160 through a fixing unit 162 such as a washer or a nut.

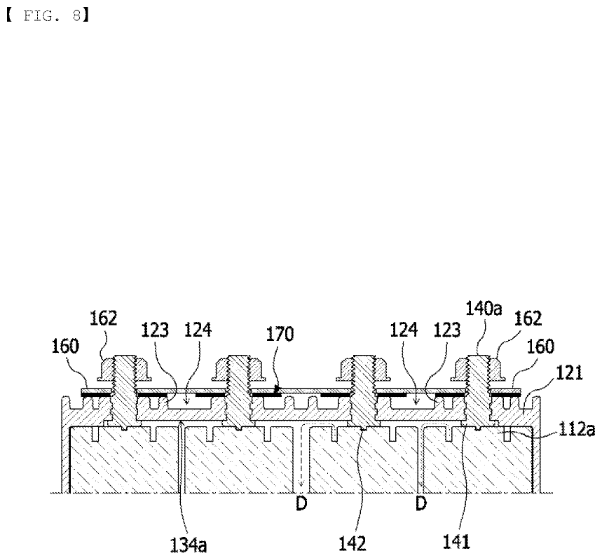

As another embodiment, it is also possible to use the contact bolt 140a of the structure shown in FIGS. 7 and 8. That is, as shown in FIG. 7, the contact bolt 140a may be manufactured by insert injection when manufacturing the holder plates 121 and 122. In this case, the contact bolt 140a may include a disc-shaped flange 141 formed with a contact protrusion 142 protruding outwardly, and a cylindrical body part 146 having a diameter smaller than that of the flange 141, and fixing parts 147 and 148 formed integrally with the body 146 and fixed to the body 146 while being embedded in the holder plates 121 and 122, and a male screw part 149 formed on one end of the body part 146 and protruding to the outside of the holder plates 121 and 122. Unlike the above-described embodiment, the contact bolt 140a shown in FIG. 7 does not include a pair of rotation tools 143 for rotating the contact bolt at both sides and a concave groove 145 for a screwdriver. The contact bolt 140a according to the present embodiment is embedded in the holder plates 121 and 122 made of synthetic resin, and is formed with fixing parts 147 and 148 not to rotate with respect to the holder plates 121 and 122.

The fixing parts 147 and 148 are formed in the area adjacent to the flange 141 in the body part 146 to prevent the contact bolt 140a from being detached from the holder plates 121 and 122, and at the same time, to prevent the contact bolt 140a from rotating in the holder plates 121 and 122 when a fixing unit 161 such as a washer, a nut, etc. is fastened to the male screw part 149 of the exposed contact bolt 140a. The fixing parts 147 and 148 preferably have a larger diameter than the diameter of the body 146, and are preferably spaced apart from each other by a predetermined interval. When a synthetic resin material is insert injected into the space between the first and second fixing parts 147 and 148 spaced apart from each other, the synthetic resin material is embedded, and the binding force is improved so that the contact bolt 140a is not detached. In addition, a first concave-convex portion 147a and a second concave-convex portion 148a are formed on the outer peripheral surfaces of the first fixing part 147 and the second fixing part 148, so that the contact bolt 140a is fixed not to rotate. In the contact bolt 140a having the above-described structure, in order to correct the tolerance between the plurality of battery cells 112, the height of the contact protrusion 142 protruding from the upper surface of the flange 141 is set with a dimensional accuracy of 0.3 mm to 0.8 mm. When the height of the contact protrusion is less than 0.3 mm, it is difficult to effectively achieve the function of correcting the tolerance for the dimensional difference of the battery cell. When the height of the contact protrusion exceeds 0.8 mm, the negative (−) terminal of the battery cell may be damaged. The contact protrusion 142 may penetrate into the surface of the electrode terminal 112a of the battery cell 112 to improve contact reliability.

The array panel 160 used in the battery cell assembly 100 having the above-described structure may be manufactured using a copper panel having excellent electrical conductivity, unlike a battery module manufactured by a conventional welding scheme. Conventionally, since the electrode terminal of the unit battery cell had to be connected to the bus bar in a welding scheme, a copper panel could not be used. However, since the battery cell assembly according to the present invention does not use a welding scheme, it is possible to use a copper panel having excellent electrical conductivity. When the array panel is constructed using copper, the internal resistance of the battery cell assembly may be minimized, and it is effective in stabilizing the electrical capacity of the battery module. In addition, there is no risk of disconnection of the contact between the contact bolt and the array panel due to heat generated by the battery cell, and electrical connection reliability may be secured even in an external shock. In addition, the contact state between each battery cell and the contact bolt may be easily checked after assembly or during use. In the battery cell assembly according to the present invention, since individual battery cells, contact bolts and array panels are mechanically assembled, it is relatively easy to replace the corresponding battery cells when a defect occurs in a specific battery cell. Unlike the related art, when a defect occurs in the battery module during use, the product may be easily repaired, so that not only the overall manufacturing cost but also the customer service cost may be significantly reduced.

Meanwhile, the metal array panel may be overheated due to the heat generated in the battery cell during use of the battery module, and thus the synthetic resin holder plate may be deformed or melted. To solve this problem, the insulating panel 170 may be interposed between the outer surfaces of the array panel 160 and the holder plates 121 and 122. In addition, the insulating panel 170 not only electrically separates the array panel 160 from the surrounding areas, but also prevents heat generated from the array panel 160 from being transferred to the holder plates. As shown in FIG. 2, the insulating panel 170 may be provided as a separate member, may be formed in a ring shape, and may be disposed while being fitted with the contact bolt 140. Alternatively, the insulating panel 170 may be formed in advance in the opening (formed at the position where the contact bolt is inserted) provided in the array panel 160 to be integrally manufactured.

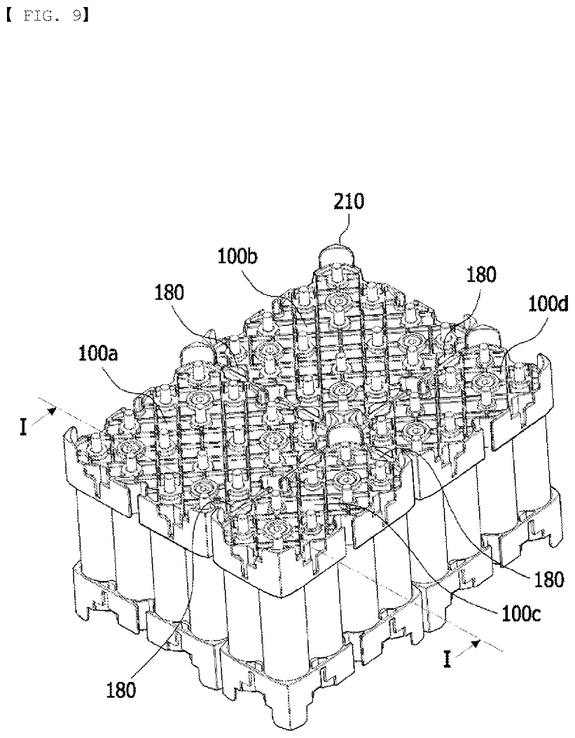

Next, FIG. 9 illustrates an example in which a plurality of battery cell assemblies is connected to each other to constitute one battery pack. For example, as shown in FIG. 9, two battery cell assemblies 100a and 100b of 4 rows and 4 columns and two battery cell assemblies 100c and 100d of 4 rows and 2 columns are connected to each other and assembled into one battery pack. In addition, it is possible to manufacture a battery pack having a structure in which the battery pack of the form shown in FIG. 9 is stacked in several layers in a vertical direction.

In order to form a battery pack having such a structure, when one battery cell assembly is fastened to another neighboring battery cell assembly, first, it should be possible to fasten and stack in a dense structure so that there is no unnecessary space between the battery cell assemblies, and secondly, assembling and disassembling between the battery cell assemblies should be easy, and thirdly, electrical separation and wiring between neighboring battery cell assemblies in a lateral or vertical direction should be easy.

Hereinafter, the units adopted for constructing an assembled battery pack by coupling a plurality of battery cell assemblies to each other in a lateral or vertical direction will be described in detail.

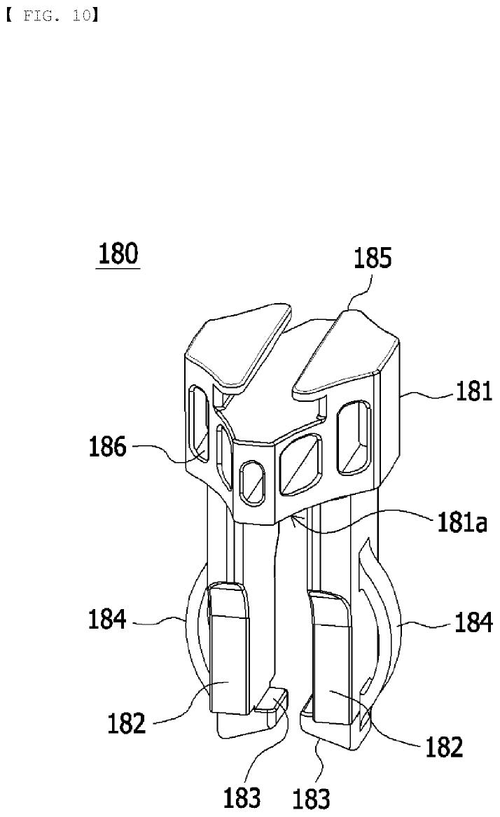

A fastening link 180 for fastening the holder plates 120 of adjacent battery cell assemblies to each other will be described with reference to FIGS. 10 to 12. In this case, the fastening link 180 may include a body part 181 provided with a seating surface 181a for the holder plates 121 and 122, a pair of fastening legs (182) extending parallel to each other from the seating surface 18a while being spaced apart from each other, a hook 183 provided at one end of each of the pair of fastening legs 182 and protruding in a direction in which hooks face each other, and a tension part 184 provided on each of the pair of fastening legs 182 and protruding in directions in which tension part face each other. In addition, the fastening link 180 may further include a removal part 185 for separating the fastening link 180 from the holder plate 121 and 122 on one surface opposite to the seating surface of the body part 181.

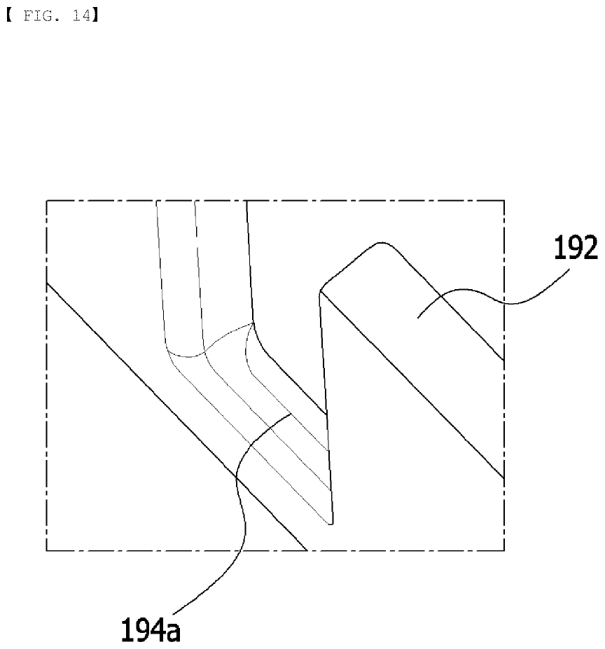

Meanwhile, referring to FIGS. 3, 4, 13 and 14, the holder plates 121 and 122 have a substantially rectangular structure, and a plurality of link insertion holes 190 may be symmetrically formed at both sides of the holder plates 121 and 122 including four peripheries, which face each other. The symmetrically formed link insertion holes 190 make it possible to continuously fasten the holder plate having the same shape in the lateral direction.

In addition, each of the plurality of link insertion holes 190 may include a support surface part 191 formed flat in an opening direction (that is, the direction passing through the outer and inner surfaces of the holder plate) of the link insertion hole 190, a stopper 192 provided on an opposite side of the support surface part 191 and supporting the seating surface 181a provided on the body part 181 of the fastening link 180, a guide groove 193 extending from the stopper 192 to guide an entry of the fastening leg 182, and a fixing rib 194 to which the hook 183 is fixed on one end of the guide groove 193. In this case, preferably, the fixing rib 194 is formed with an inclined surface part 194a inclined toward the support surface part 191.

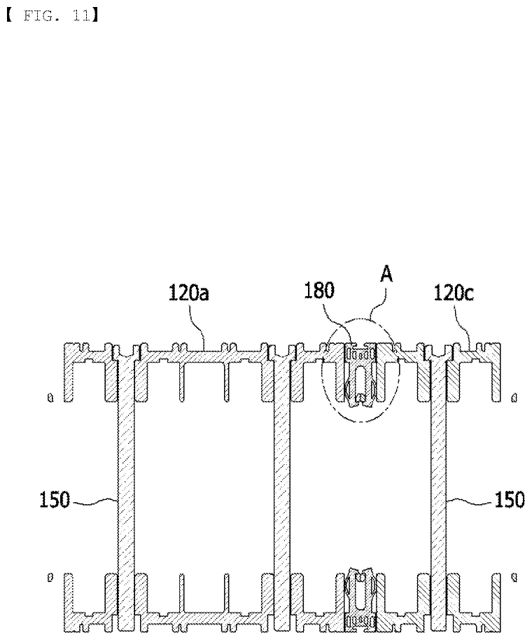

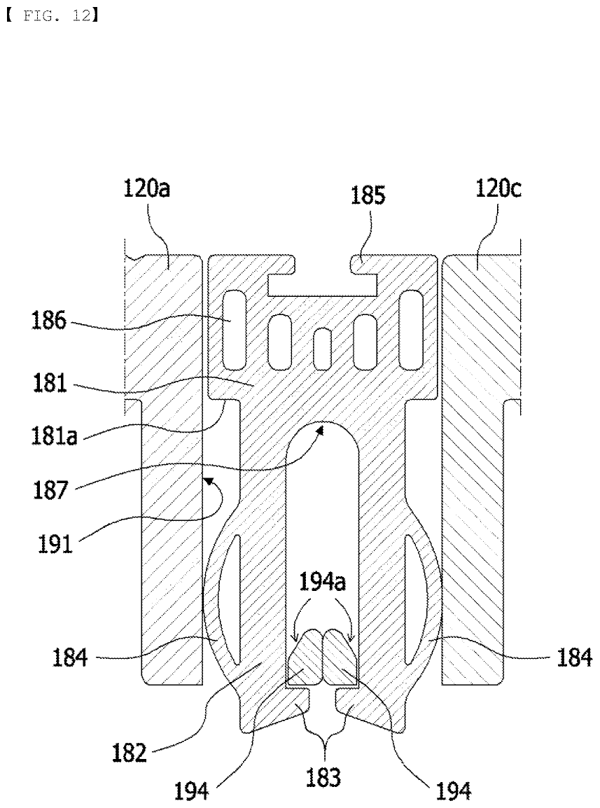

FIG. 11 is a cross-sectional view taken along line I-I shown in FIG. 9. FIG. 12 is an enlarged cross-sectional view of area A of FIG. 11.

Referring to FIGS. 11 and 12, the coupling state of the fastening link 180 and the link insertion hole 190 will be described with reference to FIGS. 11 and 12. For example, the fastening link 180 is fastened between two adjacent battery cell assemblies 100a and 100c. When the link insertion holes 190 formed in the holder plates 120a and 120c of each of the battery cell assemblies 100a and 100c are arranged to be connected adjacently to each other, fastening link 180 is inserted into a portion at that the two link insertion holes 190 are in contact with each other. In this case, the body part 181 may be formed in a shape that matches the shape formed by abutting of the two link insertion holes 190, so that two abutting link insertion holes 190 are closely fixed to the link insertion hole 190. The seating surface 181a provided on the body part 181 is latched to the stoppers 192 formed in the two adjacent link insertion holes 190. In this case, the pair of fastening legs 182 introduced along the guide groove 193 are fastened to the fixed ribs 194 formed in the holder plate 120a and the fixing rib 194 formed in the holder plate 120c, respectively. Accordingly, the two holder plates 120a and 120c may be securely fastened to each other.

In this case, while the tension part 184 is elastically deformed with respect to the support surface part 191, the hook 183 is prevented from being separated from the fixing rib 194 by an impact. The tension parts 184 are formed to protrude in opposite directions from the fastening legs 182, respectively, and are blocked by the support surface part 191 provided in the link insertion hole 190 to apply pressure in the direction in which the hooks 183 abut with each other. Meanwhile, a connecting part 187 curvedly formed in an arc shape may be provided between the pair of fastening legs 182, and the tension of the fastening legs 182 is properly maintained through the connecting part 187. In addition, the inclined surface part 194a may allow the hook 183 of the fastening leg 182 introduced along the guide groove 193 to be fixed after being spread to the outside of the fixing rib 194. In addition, the removal part 185 makes it easy to remove the fastening link 180 from the link insertion hole 190 when the battery pack is to be disassembled. The removal part 185 may be formed in a pair of protruding structures facing each other, and the fastening link 180 may be removed using a space provided between the protruding structures through a predetermined tool. Furthermore, the body part 181 may be provided with a plurality of hollow space parts 186, which not only maintain the structural rigidity of the body part 181, but also reduce the synthetic resin material, so that it is advantageous to lower the manufacturing cost.

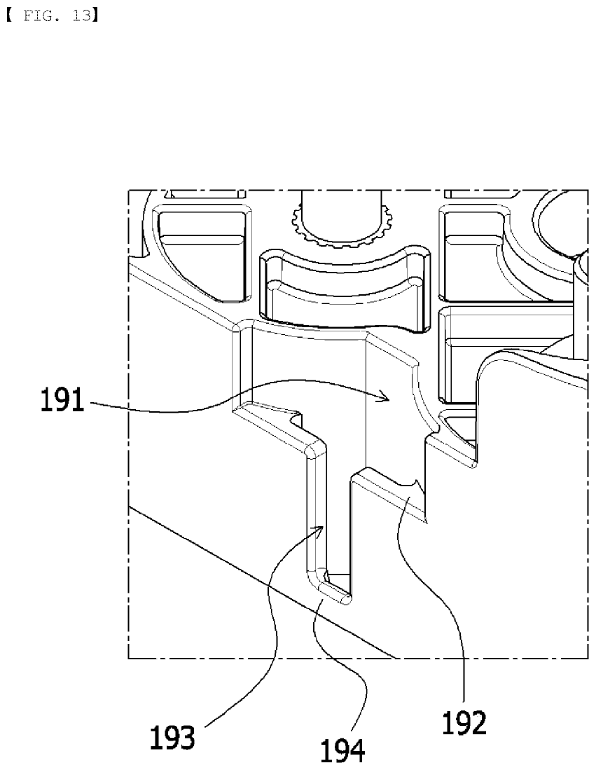

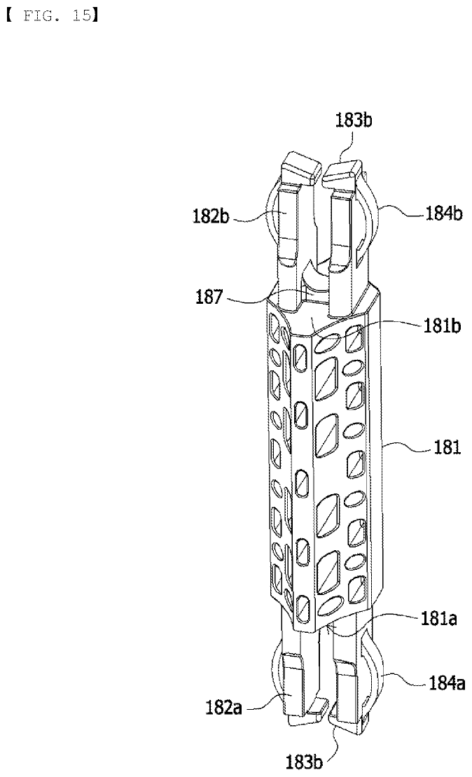

As previously exemplified, a plurality of battery packs shown in FIG. 9 may be stacked in a vertical direction. In this case, in order to fasten the battery cell assemblies stacked vertically, as shown in FIG. 15, first and second seating surfaces 181a and 181b may be formed on opposite surfaces of the body 181, respectively, and the fastening link 180 may be used in which the first pair of fastening legs 182a and the second pair of fastening legs 182b having the same shape and including the hook and the tension part on each of the first and second seating surfaces are formed. When compared with the fastening link shown in FIG. 10, the fastening link 180 shown in FIG. 13 is symmetrically formed at the upper and lower parts with respect to the body 181, except for the removable part 185.

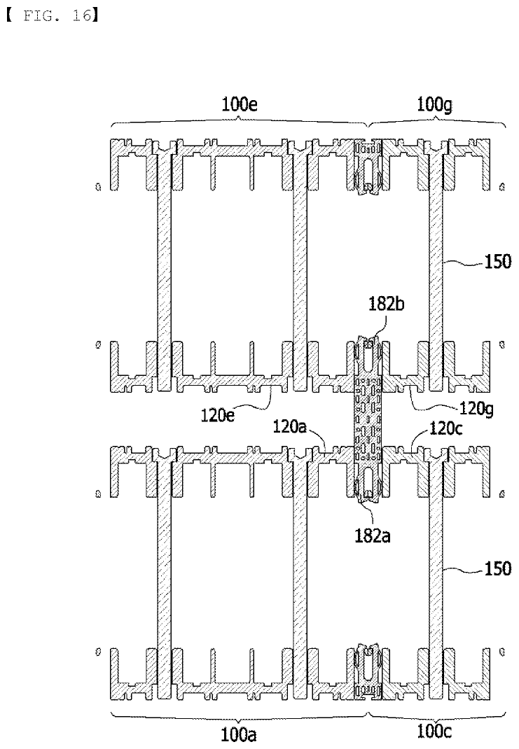

When the fastening link 180 shown in FIG. 15 is used, as shown in FIG. 16, the first battery cell assembly 100a and the second battery cell assembly 100c disposed in a lower portion may be fastened by the first pair of fastening legs 182a, and the third battery cell assembly 100e and the fourth battery cell assembly 100g disposed thereon may be fastened by the second pair of fastening legs 182b. That is, the holder plate 120a of the first battery cell assembly 100a, the holder plate 120c of the second battery cell assembly 100c, the holder plate 120e of the third battery cell assembly 100e, and the holder plate 120g of the cell assembly 100g may be firmly fixed through one fastening link. Thus, four adjacent battery cell assemblies may be stacked in a structure in which they are fastened to each other through one fastening link.

Meanwhile, when configuring the battery pack having a multi-layered structure as shown in FIG. 16, the contact bolt included in the battery cell assembly disposed thereon and the contact bolt of the battery cell assembly disposed therebelow may be in contact with each other. In the case of configuring the battery pack having a multi-stage structure in such a manner, spacers 210 formed at the four corners of the holder plates 121 and 122, respectively and higher than the protrusion length of the contact bolts are provided in order to electrically separate the battery cell assemblies adjacent vertically. In addition, a predetermined wire may be used for electrical connection between the adjacent battery cell assemblies, and in order to prevent the used wire from generating a separation distance between the adjacent battery cell assemblies, preferably, a wire receiving groove 200 for receiving the wire connected to the array panel is formed on one side of the holder plates 121 and 122.

Meanwhile, the unit battery cell constituting the battery cell array according to the present invention may use a cylindrical battery cell. As shown in FIG. 6, in general, the cylindrical battery cell 112 is housed in a jelly-roll type (wound type) electrode assembly 112c in the cylindrical case 112b, and after injecting the electrolyte into the cylindrical case 112b, the unit battery cell is manufactured by combining a cap assembly in which an electrode terminal 112a (e.g., a positive electrode terminal) is formed on an opened upper end of the case. In this case, the electrode assembly 112c has a structure wound in a round shape after interposing a positive electrode, a negative electrode, and a separator of separating the positive and negative electrodes from each other, and a cylindrical center pin 112d is inserted into the core (the central portion of the jelly-roll). The center pin 112d is generally made of a metal material to impart a predetermined strength, and has a hollow cylindrical structure obtained by bending a plate material in a round shape. The center pin 112d performs a function of fixing and supporting the electrode assembly 112c and functions as a passage for discharging gas generated by an internal reaction during charging, discharging and operation. In general, the electrode terminal 112a functions as an anode, and the case 112b functions as a cathode, and both are electrically separated by the insulator 112e.

When the battery cell 112 having the above-described structure is overheated, gas may be emitted from the inside. In this case, the gas generated inside is discharged between the insulator 112e, the electrode terminal 112a, and the cylindrical case 112b of the cap assembly. That is, the gas is emitted around the electrode terminal 112a in contact with the flange 141 of the contact bolts 140 and 140a. In the present invention, the gas exhaust groove 134 is formed such that the gas discharged from the overheated battery cell 112 can be smoothly exhausted.

In more detail, as shown in FIGS. 4 and 8, the receiving grooves 133a, in which the flanges 141 of the contact bolts 140 and 140a are received, are formed in the inner surfaces 121a and 122a of the holder plates 121 and 122, and the gas exhaust grooves 134 are formed to allow the receiving grooves 133a formed corresponding to each of the plurality of battery cells to communicate with each other. That is, the gas exhaust grooves 134 are connected to the adjacent receiving grooves 133a, and are exposed through to spaces between the adjacent battery cells 112 and spaced apart from each other. Accordingly, when gas is emitted from a specific battery cell 112, the gas may be exhausted to the outside through the receiving groove 133a and the gas exhaust groove 134. For reference, FIG. 8 is a partially sectional view of a battery cell assembly in a state in which both the insulating panel 170 and the array panel 160 are installed on the holder plate 121 in which the contact bolts 140a shown in FIG. 7 are formed by insert injection when taken long incision line I-I of FIG. 2. As shown in FIG. 8, the receiving groove 133a where the flange 141 is accommodated is preferably formed to have a larger diameter than that of the flange 141, and the adjacent receiving grooves 133a communicate through gas exhaust grooves 134. Accordingly, the gas emitted around the electrode terminal 112a of the battery cell 112 may be exhausted to the outside through the receiving groove 133a and the gas exhaust groove 134 along arrow D.

In particular, an empty space may be formed between the battery cells 112 by the position fixing grid 131, and the gas exhaust groove 134 may be disposed between the grids 131. The spaced space formed by the gratings 131 may be used as an exhaust path of the gas generated in the battery cell 112. The holder plate according to the present invention has a structure in which the inner surface of the holder plate is in close contact with both ends of the battery cell in order to improve the reliability of electrical contact with the battery cell 112. In this case, the gas generated from the battery cell 112 may be effectively exhausted by the receiving groove 133a and the gas exhaust groove 134.

Next, as shown in FIGS. 3 and 8, cross ribs 123 may be formed at a predetermined height on the outer surfaces of the holder plates 121 and 122. The cross ribs 123 have a partition structure having a constant height. The plurality of cross ribs 123 may be formed to cross, for example, in an orthogonal direction. An empty space is formed between the intersecting ribs 123 of the intersecting structure, and the space divided by the plurality of intersecting ribs functions as the heat dissipation space part 124.

The cross rib 123 reduces the weight of the holder plates 121 and 122 while improving structural rigidity. Furthermore, the heat dissipation space 124 formed by the cross ribs 123 dissipates heat generated by the array panel 160 by contacting the outside air. The insulating panel 170 is disposed under the array panel 160 to be supported by the cross ribs 123. The insulating panel 170 may be formed in a ring shape having a predetermined width. Since the insulating panel 170 is supported by the cross ribs 123, the contact area with the holder plates 121 and 122 made of synthetic resin may be minimized. Therefore, the heat generated by the array panel 160 is primarily blocked by the insulating panel 170, and since the insulating panel 170 is supported by the cross ribs 123 so that the contact area is minimized, it is possible to effectively prevent the holder plates 121 and 122 from being deformed or damaged by the array panel 160. In addition, since the upper and lower surfaces of the array panel 160 are respectively exposed to open spaces, the heat of the array panel 160 may be effectively discharged.

Although exemplary embodiments of the present invention have been described for illustrative purposes, those skilled in the art will appreciate that various modifications, additions and substitutions are possible, without departing from the scope and spirit of the disclosure. Therefore, the exemplary embodiments disclosed in the present invention are provided for the sake of descriptions, not limiting the technical concepts of the present invention, and it should be understood that such exemplary embodiments are not intended to limit the scope of the technical concepts of the present invention.

1. A battery cell assembly comprising:
a battery cell array including a plurality of battery cells;
a pair of holder plates which are made of an electric insulation material, arranged at both ends of the battery cell array to face each other, and include position fixing grids which are provided on inner surfaces thereof, respectively, while being spaced apart from each other to fix respective positions of the plurality of battery cells; and
a plurality of contact bolts made of an electroconductive material, and arranged at positions corresponding to electrode terminals of the plurality of battery cells, respectively, in which one-side ends of the contact bolts are in electric contact with the electrode terminals of the battery cells and other-side ends thereof are disposed to protrude from outer surfaces of the holder plates, respectively,
wherein the contact bolt includes a disc-shaped flange formed with a contact protrusion;
a body part having a diameter smaller than a diameter of the flange; and
a male screw part formed on one end of the body part, and
wherein the holder plate includes a receiving groove formed on an inner surface to which an end of the battery cell array is connected to receive the flange of the contact bolt; and
gas exhaust grooves formed between adjacent receiving grooves to allow the receiving grooves to communicate with each other, the adjacent receiving grooves being formed to correspond to each of the plurality of battery cells.

2. The battery cell assembly of claim 1, wherein the holder plate further includes a plurality of cross ribs formed at a predetermined height from an outer surface of the holder plate and crossed with each other; and
a plurality of heat dissipation space parts divided by the plurality of cross ribs.

3. The battery cell assembly of claim 1, wherein the contact bolt further includes a fixing part formed integrally with the body part and having a diameter larger than a diameter of the body part to fix the body part to the holder plate.

4. The battery cell assembly of claim 2, wherein the battery cell array includes one or more unit arrays; and
an array panel electrically connected to the contact bolt connected to each of a plurality of battery cells constituting the unit array.

5. The battery cell assembly of claim 4, further comprising:
an insulating panel disposed under the array panel to be supported by the cross rib to electrically separate the array panel and the holder plate and to block heat generated from the array panel from being transferred to the holder plate.

6. The battery cell assembly of claim 5, wherein the heat dissipation space part dissipates heat generated from the array panel by bringing the heat into contact with outside air.

7. The battery cell assembly of claim 1, further comprising:
a fastening link for fastening holder plates of an adjacent battery cell assembly to each other,
wherein the fastening link includes:
a body part provided with a seating surface for the holder plate;
a pair of fastening legs extending parallel to each other from the seating surface while being spaced apart from each other;
hooks provided at one end of each of the pair of fastening legs and protruding in a direction to face each other; and
tension parts provided on each of the pair of fastening legs and protruding in opposition to each other,
wherein the holder plate includes a plurality of link insertion holes formed symmetrically in two peripheries of the holder plate including four peripheries, in which the two peripheries face each other, and
wherein each of the plurality of link insertion holes includes a support surface part flattened in an opening direction of the link insertion hole;
a stopper provided on an opposite side of the support surface part and supporting the seating surface provided on the body part of the fastening link;
a guide groove extending from the stopper to guide an entry of the fastening leg of the fastening link; and
a fixing rib formed on one end of the guide groove to fix the hook of the fastening link.

8. The battery cell assembly of claim 7, wherein the fastening link includes a removal part formed on one surface opposite to the seating surface of the body part to separate the fastening link from the holder plate.

9. The battery cell assembly of claim 7, wherein the fastening link is formed with first and second seating surfaces on both surfaces of the body part facing each other, and the first and second seating surfaces are formed with a pair of first fastening legs and a pair of second fastening legs having a same shape and including the hook and the tension part, respectively.

10. The battery cell assembly of claim 7, wherein the fixing rib includes an inclined surface part inclined toward the support surface part.
